(19) United States
(12) Patent Application Publication
(10) Pub. No.: US 2007/0086364 A1
(43) Pub. Date: Apr. 19, 2007

(54) Methods and system for a broadband multi-site distributed switch

(75) Inventors: Donald Ellis, Ottawa (CA); Martin Charbonneau, Hull (CA); Adrian Bashford, Ottawa (CA); Jean Turgeon, Gatineau (CA)

Correspondence Address: SMART & BIGGAR;P.O. BOX 2999, STATION D, 900-55 METCALFE STREET, OTTAWA, ON, K1P5Y6, CA

(73) Assignee: NORTEL NETWORKS LIMITED

(21) Appl. No.: 11/239,131

(22) Filed: Sep. 30, 2005

(51) Int. Cl. H04L 12/28

(52) U.S. Cl. 370/258

(57) ABSTRACT

Systems and methods are provided for a multi-floor and/or multi-site distributed switch. As video applications such as “video on demand” (VoD) start to become more used by the general public and desire for combining networks capable of carrying voice, data, internet and video increases, service providers are requiring broadband networking capabilities that require new scaleable infrastructure solutions. Existing network technologies are not flexible enough to deliver broadband traffic required for each floor of a multi-floor network data center (NDC) or multiple NDCs connected in a ring. Conventional solutions involve direct cabling from each floor to a common room on one floor of the site. Embodiments of the present invention provide for a distributed switch including a plurality of switching elements on different floors/sites that is non-blocking under defined traffic conditions. By understanding some key dynamics of the NDC, including the attributes of the services being implemented and what functionality exists on each floor, the distributed switch is designed to handle a capacity much greater (>>3×) than independent monolithic switching elements on each floor joining in a “meet-me” room.

### FIELD OF THE INVENTION

The invention relates to broadband networks, in particular to broadband network switching.

### BACKGROUND OF THE INVENTION

A network data centre (NDC) model being adopted more frequently for dealing with broadband communication services such as voice, data, internet and video communications is a hierarchy of sites in which down stream communications flow from national NDCs to regional NDCs, which in turn communicate with metro NDCs. These metro NDCs typically communicate with many local Access NDCs. The Access and Metro NDCs are connected directly to local service recipients such as enterprises and local customers. In the NDC model, a site or building has multiple floors in which each floor has a particular purpose. One floor acts as a transport floor to communicate to other NDCs higher-, peer- and lower-level in the hierarchy, another floor acts as an access floor to communicate with local service recipients, another floor acts to host gateways to data or voice networks or possibly servers for video broadcast of multicast and/or unicast information. Additional floors may include floors for dealing with management and command and control issues within the network as a whole or the site itself.

As video applications such as “video on demand” (VoD) start to become more used by the general public and desire for combining networks capable of carrying voice, data, internet and video increases, service providers are requiring broadband networking capabilities that require new scaleable infrastructure solutions. To provide these broadband services many aspects of existing networks need to be scaled, for example Access going from N×1.5/2 Mb/s to N×1 Gb/s, Voice from N×64K switching to N×1 Gb/s Voice Server technology, Data ranging from N×64K to N×1.5/2 Mb/s data access moving to 10/100 Mb/s and Transport ranging from N×1.5/2 Mb/s to N×50 Mb/s moving to N×10 Gb/s.

Existing network technologies are not flexible enough to deliver connectivity required for each floor or site. Conventional solutions involve direct cabling from each floor to a common room on one floor of the site. Existing monolithic switching elements used on individual floors of a site or at respective sites in a network need to be independently configured to interact with each other. This leads to a large provisioning requirement and high level of co-ordination between floors/sites.

FIG. 9 shows an example of such a conventional implementation in which a site has a first floor for transport, a second floor for access, a third floor for application hosting and a fourth floor for management and command and control. The first, second and fourth floors each have a respective switch 810,820,830 on each respective floor that includes ports that are connected to one or more inputs or outputs on each respective floor. The switches 810,820,830 on the first, second and fourth floors also have ports that are connected to links that are directly cabled to a switch 840 or a passive patch-panel in a common room shown, for illustration, on the first floor of the site. On the third floor, individual devices 850,851,852, for example application servers, are each directly cabled to the switch 840 in the common room. All traffic between floors must flow through the switch 840 in the common room, or bypass it by means of a direct connection via the patch-panel. Furthermore, each switch 810,820,830,840 must be individually configured to communicate with the switch to which it is connected. To provide a non-blocking switching environment between floors that can be provisioned flexibly, the switch 840 in the common room must have a switching capacity equal to the sum of the inputs and outputs of the bandwidths of the links connected to it. As the desire for combining broadband services such as data, voice and video increases, such a conventional model will require very large bandwidth capable switches. As the bandwidth requirement for switches increases, the switches become increasingly expensive to design and manufacture. To avoid large capital increases due to these expensive high bandwidth switches, another solution is required.

In addition, traditional trunking methods between these switches have resulted in only a small portion of the bandwidth being allocated for between floors/sites and any large bandwidth interconnects being offered only on the floor to which the trunk is connected. Often large fan-in is offered per floor, but only a limited amount of floor to floor bandwidth, often referred to as vertical riser bandwidth, is available. The interconnect may offer link protection, however, it is usually limited to port applications and is not considered a part of the switch fabric.

Current stackable switching technologies can provide certain aspects of the functionality desired for Data Centers used for Enterprise services, which are usually restricted to one floor. They do not provide for the scalability, resiliency and virtual-non-blocking nature desired in an efficient and cost-effective broadband carrier network infrastructure. Broadband carrier solutions generally will not fit into a single one floor Data Center.

Video broadcast (multicast and/or unicast) of entertainment video is not addressed by Enterprise Data Center applications and new Carrier Data Center solutions for both local exchange carriers (LECs) and multiple system cable operator (MSO) both require multi-floor or multi-site Data Centers.

### SUMMARY OF THE INVENTION

According to a first aspect of the invention, there is provided a distributed switch for use in a broadband multimedia communication network comprising: an interconnection ring extending over more than one floor of a site in the network; a plurality of switching elements, each network switching element on a different floor of the site in the network, wherein each switching element is coupled to at least one other switching element via the interconnection ring; wherein the plurality of switching elements collectively provide a non-blocking connection between any two switching elements of the site under defined traffic conditions.

According to an embodiment of the first aspect of the invention, the defined traffic conditions are at least in part based on one or more of: oversubscription of services, multiplexing of services, and distribution of bandwidth amongst the plurality of switching elements.

According to another embodiment of the first aspect of the invention, bandwidth provisioned for input/output ports of each switching element coupled to the interconnect ring is less than the combined bandwidth provisioned for input/output ports of each switching element coupled to links that are coupled to the interconnect ring via the switch.

According to another embodiment of the first aspect of the invention, at least one switching element is coupled to at least one of: at least one local service recipient; at least one switching element at a remote site from the site comprising the plurality of switching elements; at least one application server; at least one gateway to another network; and at least one management and control server.

According to another embodiment of the first aspect of the invention, the distributed switch further comprises: at least one remote site each comprising one or more switching elements; a second interconnection ring; a switching element of the plurality of switching elements of the site and a switching element of the one or more switching elements of the at least one remote site coupled together via the second interconnection ring, wherein the switching element of the at least one remote site and the plurality of switching elements collectively provide a non-blocking connection between any two switching elements of the site and the remote site under defined traffic conditions.

According to another embodiment of the first aspect of the invention, the plurality of switching elements comprises a first switching element on a first floor, a second switching element on a second floor, and a third switching element on a third floor, wherein: the first switching element on the first floor is coupled to one or more switching elements at the site and one or more switching elements at remote sites, the first switching element adapted for switching signals to and from the one or more switching elements at remote sites and the one or more switching elements to which the first switching element is coupled; the second switching element on the second floor of the site is coupled to one or more switching elements at the site and one or more local service recipients, the second switching element adapted for switching signals to and from the one or more local service recipients and the one or more switching elements to which the second switching element is coupled; and the third network element on the third floor of the site is coupled to one or more switching elements at the site and at least one application server and/or at least one network gateway, the third network element adapted for switching signals to and from the at least one application server and/or at least one network gateway and the one or more switching elements to which the third switching element is coupled.

According to another embodiment of the first aspect of the invention, the distributed switch further comprises a fourth switching element on a fourth floor of the site, wherein; the fourth switching element is coupled to one or more switching elements at the site and one or more management and control servers, the fourth switching element adapted for switching signals to and from the one or more management and control servers and the one or more switching elements to which the fourth switching element is coupled.

According to another embodiment of the first aspect of the invention, there are more than one of any of the first switching element, second switching element and third switching element, each located on a respective additional floor.

According to another embodiment of the first aspect of the invention, the distributed switch is used in communicating any one or more of a combination of signal types consisting of voice, data, internet and video.

According to another embodiment of the first aspect of the invention, video is either multicast broadcast or unicast broadcast.

According to another embodiment of the first aspect of the invention, at least one of the plurality of switching elements is adapted to supply a timing reference synchronization signal to any or all of the other switching elements of the plurality of switching elements in the distributed switch when there is a loss of a primary synchronization signal.

According to another embodiment of the first aspect of the invention, the high capacity cabling interconnection ring uses ethernet protocol as the physical media.

According to a second aspect of the invention, there is provided a switching device for use in a distributed switch comprising: a first plurality of input/output ports for receiving and sending signals to and from other switching elements located on different floors of the multi-floor site; at least one ring card coupled to the plurality of first input/output ports; a switching fabric coupled to the at least one first ring card; at least one tributary card coupled to the switching fabric; a second plurality of input/output ports for receiving and sending signals to input/outputs on the floor of the multi-floor site on which the switching element is located, the second plurality of input/output ports coupled to outputs of the at least one tributary card; wherein when coupled together with one or more similar switching elements on different floors, the switching elements collectively forming a distributed switch to provide a non-blocking connection between any two switching elements of the site under defined traffic conditions.

According to an embodiment of the second aspect of the invention, port protection is provided by having a third plurality of input/output ports which are redundant for the first plurality of input/output ports and a fourth plurality of input/output ports which are redundant for the second plurality of input/output ports.

According to another embodiment of the second aspect of the invention, ring card and/or tributary card protection is provided by having at least a second ring card which is redundant for the ring card and/or a second tributary card which is redundant for the tributary card, respectively.

According to another embodiment of the second aspect of the invention, switching fabric protection is provided by having at least a second switching fabric which is redundant for the switching fabric.

According to another embodiment of the second aspect of the invention, protection is provided by having redundant components in the network element, the redundant components consisting of one or more of additional input/output ports, ring cards, tributary cards and additional switching fabrics.

According to another embodiment of the second aspect of the invention, tributary card, ring card and switching fabric additions or replacements within the switching device, software upgrades and other maintenance do not disrupt ongoing service of the switching device, the distributed switch of which the switching device is a part, or the broadband multimedia communication network of which the distributed switch is a part.

According to another embodiment of the second aspect of the invention, a tagging mechanism is used by the switching element to forward packets on the interconnect ring, the tagging mechanism involving the switching fabric internal to the switching elements.

According to another embodiment of the second aspect of the invention, the switching element is adapted to provide signal replication on a respective floor of the site.

According to another embodiment of the second aspect of the invention, the switching element further comprises: an interface to an external timing reference; Stratum 3 holdover functionality; wherein the switching element is adapted to supply a timing reference synchronization signal from the external timing reference to the plurality of switching elements in the distributed switch when there is a loss of a primary synchronization signal.

According to a third aspect of the invention, there is provided a method for use with a distributed switch in a broadband multimedia network comprising: installing an interconnection ring extending over more than one site of a multi-site network; installing a plurality of switching elements, a switching element at each site of the network; connecting each switching element to at least one other switching element via the interconnection ring; provisioning bandwidth for traffic travelling on the interconnection ring in part based on one or more of: oversubscription of services, multiplexing of services, and distribution of bandwidth amongst the plurality of switching elements; wherein the plurality of switching elements collectively provide a non-blocking connection between any two switching elements of the site under defined traffic conditions.

According to an embodiment of the third aspect of the invention, the method further comprises: reviewing the bandwidth provisioning of the plurality of switching elements of the network on a periodic basis; re-provisioning bandwidth as capacity needs of the network change.

According to another embodiment of the third aspect of the invention, the method further comprises the steps of: installing a second interconnection ring extending over multiple floors of a site including more than one floor in the multi-site network; installing a plurality of switching elements, a switching element on each floor of the site; connecting each switching element to at least one other switching element via the interconnection ring; provisioning bandwidth for traffic travelling on the second interconnection ring in part based on one or more of: oversubscription of services, multiplexing of services, and distribution of bandwidth amongst the plurality of switching elements.

According to another embodiment of the third aspect of the invention, reviewing and re-provisioning comprises reviewing and re-provisioning from a central location that is local to one site and remote from all the other sites in the multi-site network.

Some embodiments of the invention provide a high capacity bandwidth distributed switch solution for use, in particular, with pre-cabled network links and allow 1:n, 1:1, and 1+1 protection at a component level within switching elements of a distributed switch, at the switching element level and at a multi-switching element site level.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Preferred embodiments of the invention will now be described with reference to the attached drawings in which:

FIG. 1 is a schematic diagram of a Network Data Centre (NDC) model that can be used to implement embodiments of the invention;

FIG. 2 is a schematic diagram of a NDC according to an embodiment of the invention;

FIG. 3 is a schematic diagram of an example NDC according to an embodiment of the invention;

FIG. 4 is a block diagram of a switching element for use in a distributed switch according to an embodiment of the invention;

FIG. 5 is a block diagram of a switching element for use in a distributed switch according to another embodiment of the invention;

FIG. 6 is a schematic view of a multi-floor distributed switch according to an embodiment of the invention in operation;

FIG. 7 is a block diagram of a multiple site distributed switch according to an embodiment of the invention in operation;

FIG. 8 is a flow chart for a method for use with a distributed switch according to an embodiment of the invention; and

FIG. 9 is a schematic diagram of a conventional switching solution for a multi-floor building.

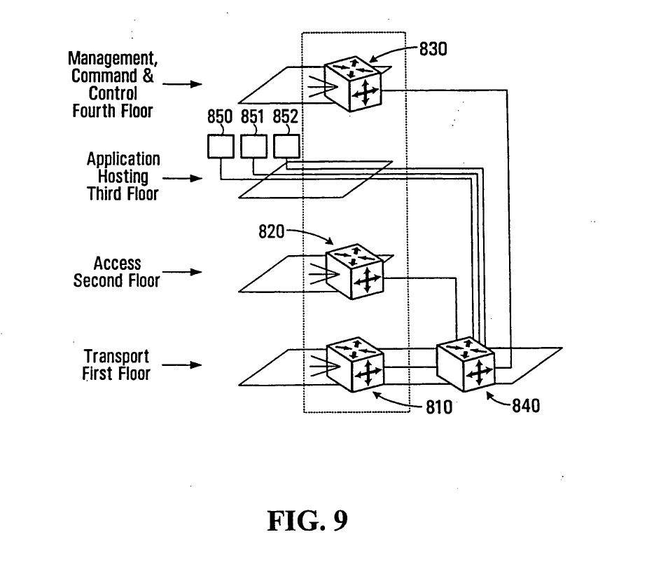

### DETAILED DESCRIPTION OF THE PREFERRED EMBODIMENTS

Networks for delivering services such as data, voice and internet to consumers and enterprises have conventionally used primary level offices having local and tandem voice switches for public switch telephone network (PSTN), Digital X-connects for Private Line services, and wide area network (WAN) routers for Data and Internet services. The services are then provided to the consumers or enterprises through both these offices and secondary level offices supported by primary offices.

As consumers and enterprises show an increased desire for more bandwidth, it is very difficult to accommodate the number of users that currently access the primary central office for these services unless new larger bandwidth switches are developed. For example, VoD is a growing consumer market. Consumers can access programming such as a particular television show or movie whenever they wish. VoD is a unicast service that requires a huge amount of bandwidth.

The present invention provides systems and methods having suitable combinations of scalability and/or resiliency and/or connectivity. By providing a multi-node distributed switch operating over multiple floors of a single building or extending to multiple sites of the network, it is possible to distribute broadband services in a network with high bandwidth availability and in a manner that does not require an even larger bandwidth switch than that which would be required to be developed for handling voice, video and data broadband services using a conventional model as described above. A benefit of embodiments of the invention described herein is that service providers would not have to incur a cost of a large bandwidth switch, which they may not fully utilize at the time of installation. Following pre-cabling of links of a network they can buy less expensive switching components and add additional switching components or modules for the switching components for added bandwidth as needed.

The multi-node distributed switch concept is a manner to address switching requirements that occur between floors of a building, or site, and between multiple sites in a network while maintaining scalability, resiliency and non-blocking communications in the network. The multi-node distributed switch appears as a single entity, forming a “distributed virtual backplane” between nodes and provides resiliency between switching points. In some embodiments, the “distributed virtual backplane” consists of a high capacity interconnect in the form of a multi-floor ring and/or a multi-site ring.

In some embodiments, switching nodes on a transport floor of multiple different NDCs are coupled to one another via a high capacity interconnection ring. This expands the distributed nature of the switch. Switches on different floors of different NDCs of the network do not need to discern whether other switches are collocated on the same floor or even in the same DCN.

Some embodiments of the invention employ pre-cabling. Pre-cabling involves cabling between nodes or network elements of the network before installing the active components of the invention. Pre-cabling can involve installing high capacity interconnection for use on a given floor of a broadband distribution site, and/or installing a high capacity interconnection ring extending over more than one floor of the site, and/or installing a high capacity interconnection riser ring connecting more than one site in the network, and/or installing cabling between local service recipients, such as enterprises and customers and a nearby broadband distribution site.

Some embodiments of the invention employ a reserved backplane bandwidth that is used to interconnect each switching point. A loop forwarding algorithm allows for backplane bandwidth to be hashed over multiple physical paths and is efficiently routed to allow for spacial re-use on the ring. The term hashed refers to each switch in a loop using an algorithm that chooses which path each data frame takes to its destination. This can be based on shortest-path, least-congested path, or in the case of a failure, the best available path. Hashing is a means to take advantage of the bandwidth available by splitting traffic over multiple paths by means of a selection mechanism. Typically hashing in the data world is done by frame MAC address, packet IP address, or is flow-based.

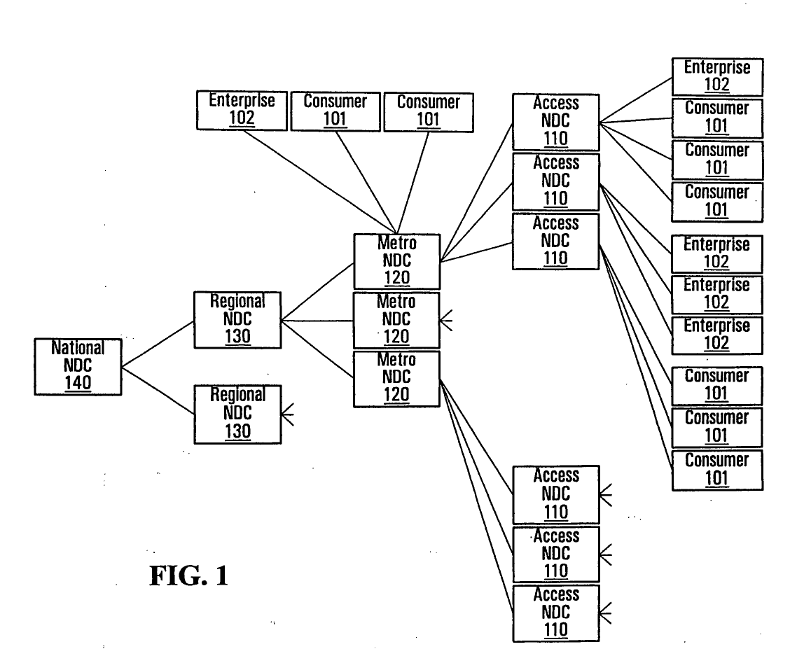

FIG. 1 shows a block diagram of the hierarchy in connectivity of a system according to an embodiment of the invention. National NDC 140 is coupled to one or more Regional NDC 130. Each Regional NDC 130 is coupled to one or more Metro NDC 120. Each Metro NDC 120 is coupled to one or more Access NDCs 110. Access NDCs are responsible for providing services directly to consumers 101 and enterprises 102. In some embodiments, Metro NDCs 120 also provide services directly to consumers 101 and enterprises 102.

The Metro NDCs 120 and Access NDCs 110 are often referred to as Tier 1 and Tier 2 and/or Tier 3 sites in the network, respectively. The Metro NDC 120 is a Tier 1 and is used for serving customers connected directly to the Tier 1 via copper and fiber and distributing services to Tier 2 NDCs. An Access NDC 110 with enterprise access is Tier 2. An Access NDC 110 with customer access is Tier 3. Tier 2/3 is an Access NDC 110 with some enterprise access, as well as customer access.

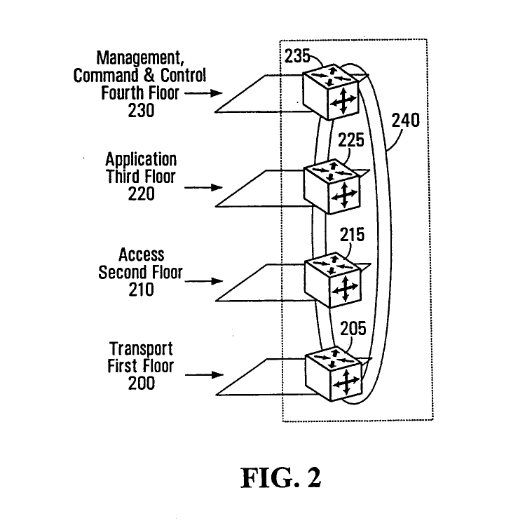

FIG. 2 shows an example configuration of a network data centre (NDC) including a multi-floor distributed switch. A first floor 200 of the NDC is dedicated to transport between other NDCs and includes a first switching element 205. A second floor 210 of the NDC is dedicated to access of customers and enterprises and includes a second switching element 215. A third floor 220 of the NDC is dedicated to hosting application servers and or gateways to other networks and includes a third switching element 225. A fourth floor 230 of the NDC is dedicated to hosting management servers and includes a fourth switching element 235. The first, second, third and fourth switching elements 205,215,225,235 are coupled together with a high capacity bandwidth interconnect 240.

In some embodiments, the high capacity bandwidth interconnect 240 consists of an interconnect in the form of a multi-floor ring.

Due to the desire for more bandwidth, Access floors are moving from digital (E1, DS1, DS3) to many Gig-Ethernet, pre-wired analog MDF (Main Distribution Frame) to pre-wired Ethernet ADSL (asymmetric digital subscriber line), VDSL (Very high speed digital subscriber line), EDF copper and fiber, transport floors moving from digital access to many Gig-Ethernet and from SONET/SDH IOF (inter-office facility) to N×10 G Ethernet IOF, pre-wired DS3 (DSX-3) to pre-wired Ethernet—EDF copper and fiber, voice and data switching floors from digital interconnect to Ethernet Inter-connect, pre-wired DS1/3 (DSX) to pre-wired Ethernet—EDF copper and fiber, analog access MDF to Ethernet, and Digital cross-connect to Ethernet.

The access floor may include equipment to terminate local copper loops, fiber systems to HFC (hybrid Fiber Co-axial) or remote DSLAMs (Digital Subscriber Line Access Multiplexing) to subscribers.

The third floor may include servers and/or storage to support applications (e.g. video), servers used as gateways to data networks, servers used as gateways to voice networks, and/or servers used as gateways to internet networks.

The fourth floor may include servers for managing and controlling aspects of the network and in particular local service recipient related issues. For example, linking to a management system of the network, session control and tracking, linking to an inventory system of the network, and alarm tracking.

Expected traffic flows on the network include multicast broadcast traffic, command and control (C&C) traffic, operation, administration, management and provisioning (OAM&P) traffic, content mirroring traffic and unicast broadcast traffic. Multicast broadcast traffic includes traffic from upstream NDCs arriving at the transport floor of the NDC and being switched to downstream NDCs and/or the access floor to be delivered to local service recipients. Multicast may include video being broadcast to all local service recipients or multimedia conference calls to multiple local service recipients. C&C traffic includes traffic flowing between the management and control floor and any or all of the application floor, the access floor and the transport floor. C&C traffic includes traffic involved with managing content for local service recipients. For example, servers on the management and control floor tracking requests for services made by local service recipients, maintaining billing information for services used by local service recipients, ensuring that requested services are initiated i.e. instructing a VoD server to transmit a requested video program to a local service recipient, and ensuring proper encryption of a signal to a local service recipient to either allow the signal to be receiver or ensure it is blocked i.e. in the case of a multicast pay-per-view event or a unicast VoD event. OAM&P traffic includes traffic flowing between the management and control floor and any or all of the application floor, the access floor and the transport floor. OAM&P traffic includes traffic involved with managing the network. For example, servers on the management and control floor monitoring alarms that indicate a failure at a given point in the network and/or tracking resources in the network i.e. different types of application servers on the application floor and the hardware and software content on those servers. Content mirroring traffic includes traffic between the application floor and upstream NDCs. Content mirroring includes upstream NDCs providing content for application servers on the application floor. In some embodiments the content is provided to multiple application servers for protection in case one application server fails or to simply ensure there is sufficient access to the content. Examples of content may include video content for multicast or unicast. Unicast broadcast traffic includes traffic between the application floor, the access floor and the transport floor. Unicast content includes application servers providing content including, but not limited to, video content, such as VoD, to local service recipients via the access floor or downstream NDCs via the transport floor.

C&C and OAM&P traffic do not typically utilize as large an amount of bandwidth as multicast and unicast broadcast and/or content mirroring use. Unicast broadcast in particular utilizes large amounts of bandwidth due to its basic nature of delivering bandwidth intensive content to as many local service. recipients desire it, whenever it is desired.

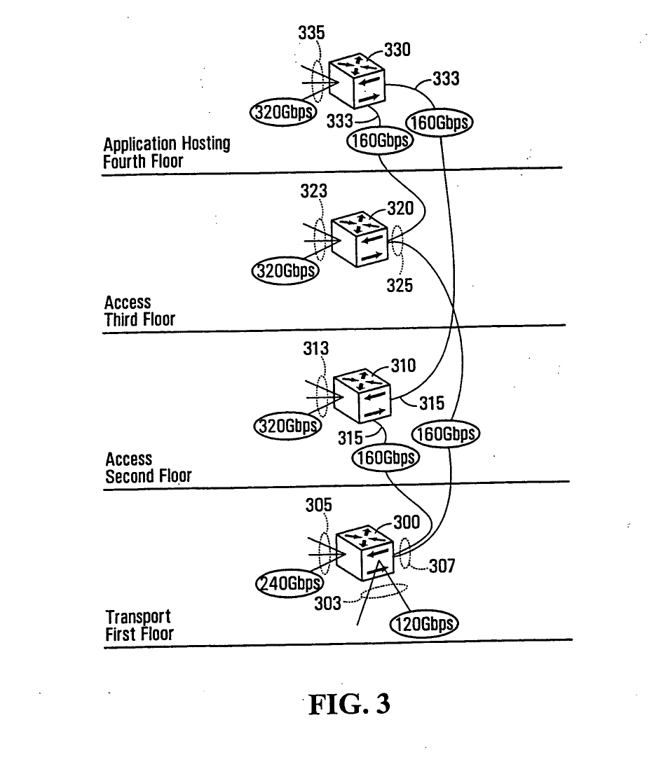

FIG. 3 shows a specific example of an NDC having multiple floors such as described in FIG. 2. In this example there are two access floors, floor two and floor three, in the NDC instead of just one as shown in FIG. 2. The floor hosting management servers for C&C and OMA&P is also not shown in FIG. 3. The numerical values in the ovals represent the bandwidth in gigabytes per second on for the respective ports of the switches.

The first floor is the transport floor and has a switching node 300 with a first group of trunk ports 303 for connection to upstream NDCs having 120 Gbps (Gigabytes per second) of bandwidth and a second group of trunk ports 305 for connection to downstream NDCs collectively having 240 Gbps of bandwidth. The switching element 300 also has riser ports 307 for connection to two other switching nodes on separate floors of the NDC via respective riser links, one switching node on each of the second and third floors, and wherein each riser link coupled to the riser ports collectively have 160 Gbps of bi-directional bandwidth. A switching node 310 on the second floor has access ports 313 for connection to Consumer and/or Enterprise Access collectively having 320 Gbps of bandwidth and riser ports 315 for connection to two switching nodes via respective riser links, the switching node 300 on the first floor and a switching element on the fourth floor, wherein each riser link coupled to the riser ports 315 collectively has 160 Gbps of bi-directional bandwidth. A switching node 320 on the third floor has access ports 323 for connection to Consumer and/or Enterprise Access collectively having 320 Gbps of bandwidth and riser ports 325 for connection to two switching nodes via respective riser links, the switching node 300 on the first floor and the switching node on the fourth floor, wherein each riser link coupled to the riser ports 325 collectively has 160 Gbps of bi-directional bandwidth. The fourth floor, which is the application hosting floor, has a switching node 330 with riser ports 333 for connection to the switching nodes 310,320 on the second and third floors via respective riser links, each riser link coupled to the riser ports 333 collectively has 160 Gbps of bi-directional bandwidth and connection ports 335 for connecting to servers (not shown) that the floor is hosting, the connection ports 335 collectively having 320 Gbps of bandwidth.

In this particular example there is no direct connection from the application servers on the fourth floor to transport on the first floor, but signals can be routed from the application servers to transport via either of the switching nodes 310,320 on the second or third floors.

In some embodiments of the invention the bandwidth provisioned for the interconnect ring between floors does not utilize the maximum capacity of bandwidth that is cabled between floors. This allows additional bandwidth to be provisioned over time as the bandwidth requirements between floors change. For example, links in the interconnect ring may be provisioned to utilize only 20 percent of the installed and available capacity of the links at the time the switching elements are initially installed at the site. Furthermore, in some embodiments not all of the links in the interconnect ring are provisioned with the same bandwidth. Bandwidth between different switching elements on the different floors can be provisioned taking into account that traffic conditions between different floors have a differing amount of usage. For example, in some instances in a Tier 1 NDC, traffic between the application hosting floor and access floor is greater than from the transport floor to the access floor.

In some embodiments, the links of the high capacity interconnect ring are connected in a manner that the switching elements on adjacent floors are connected and the switching elements on a top and a bottom floor are connected. For example, the switching element on the first floor is connected to the switching element on the second floor, the switching element on the second floor is connected to the switching element on the third floor, the switching element on the third floor is connected to the switching element on the fourth floor, and the switching element on the fourth floor is connected to the switching element on the first floor.

In other embodiments, the links of the high capacity interconnect ring are connected in a manner that each switching element on each floor is connected to two other switching elements on other floors, but the floors are not necessarily adjacent floors. This is shown in FIG. 3. When two or more floors of the same type are located at a site, such as two access floors, bandwidth can be provisioned between the switching elements of the two or more floors in such a manner that the bandwidth is provisioned between two or more links in an implementation specific ratio. This type of division of bandwidth can be effective at reducing the bandwidth provisioned for any particular link in the interconnect and consequently allow for less expensive, lower bandwidth switching elements than would otherwise be used for links provisioned to carry the entire bandwidth to a single floor. In some embodiments, the ratio of the bandwidth is divided between two or more switching elements in a manner in which traffic conditions of the switching elements can be used in the provisioning of the bandwidth to provide non-blocking functionality between switching elements that make up the distributed switch.

More generally, the bandwidth provisioned to be input/output from one switching element can be provisioned to switching elements on any two or more floors to which the one switching element is coupled such that the bandwidth on the respective links is distributed in an implementation specific manner rather than having for example, only one of the links provisioned to carry high bandwidths with respect to other links. In some embodiments, the distribution of bandwidth is particularly effective due to the ring formation in which the switching elements are connected.

In some embodiments, the maximum link lengths for the high capacity interconnect are approximately 300 meters. In some embodiments, the maximum link lengths for the cabling from the switching elements to servers on the floors is approximately 100 meters. However, depending on the type of cabling used for the links of the high capacity interconnect or on floor cabling, the lengths of cable are implementation specific.

In some embodiments, application hosting floors utilize multimode fiber cabling on the floor from application servers to connection ports of the switching device. In other embodiments, cabling on the floor is electrical cabling. Switching elements on these floors may support 1 GigE (SX, TX) and 10 GigE ethernet.

In some embodiments, connections from local service recipients such as consumers or enterprises to the access ports of the switching elements on the second and third floors are provided by single or multimode fiber cabling. In other embodiments, the connections are provided by electrical cabling. Switching elements on these floors may support 1 GigE (SX, TX, ZX, LX, BX, CWDM) and 10 GigE.

In some embodiments, connections to the trunk ports of the switching element on the first floor to other NDCs are provided by single mode fiber. Switching elements on these floors may support 1 GigE (LX, BX, ZX), 10 GigE (WAN or LAN PHY, WDM SFP) or 40 GigE (WAN or LAN PHY, WDM SFP).

In some embodiments, high bandwidth interconnections between floors are provided by optical fiber cabling. In some embodiments, the high bandwidth interconnections allow for incremental additions to increase bandwidth, for example 40 Gb increments.

Cabling between NDCs is via single mode optical fiber, or carried on a wavelength by an underlying WDM system.

More generally, the cabling used on floors of an NDC, between floors of the NDC, between NDCs, and from local service recipients to NDCs is implementation specific and can support any type of communication protocol used for such connections.

In some embodiments, the high capacity cabling interconnection ring uses ethernet protocol as the physical media. Examples of such physical media are Etherent, SONET or Infiband.

The features designated for each floor (transport, access, application hosting) are implementation specific and may be configured such that they are on different floors than that shown in FIG. 3. The number of floors utilized for a given feature are also implementation specific. In some embodiments, there may be greater than or fewer than two access floors, more than one transport floor, or more than a single server host floor. The connections between each floor are therefore also implementation specific and may have any configuration where a switching element on a particular floor is connected to a switching element on two or more other floors. Furthermore, the allotment of bandwidth to different ports of the switching elements on the various floors is also considered to be implementation specific.

The following descriptions refer to a “floor side” and a “riser side” of the switching node or switching element. This designation is used to refer to respective sides of the switching element. The “floor side” is a side that, for example, the servers on the application hosting floor are connected to, or on the access floors, the side that access connections to local service recipients are connected, or on the transport floor, the side that downstream or upstream NDCs for a particular DNC are connected. The “riser side” is the side of the switching element that is connected to the high capacity interconnect. In multi-site examples discussed below the “riser side” is referred to the “ring side”.

When provisioning broadband signals on a network there are attributes associated with transmission of different types of signals that are taken advantage of in embodiments of the invention. For example, when provisioning high speed data (HSD), such as internet traffic, typically not every user subscribing to an internet service is on the network every hour of the day. Therefore, HSD bandwidth can be provisioned on the riser side of the switch in such a manner that the bandwidth accessible on the riser side of the switching element is significantly less than the bandwidth allocated to the floor side of the switching element on the access floor. HSD bandwidth on the ring side of the switching element can be provisioned from 50 to 100 times less than the bandwidth allocated for inputs/outputs on the floor side of the switching elements due to accepted oversubscription protocols for this type of service. Similarly, VoIP (Voice over Internet Protocol) traffic bandwidth on the ring side of the switching element can be provisioned from greater than 1 to 2 times less than the bandwidth allocated for inputs/outputs on the floor side of the switching. Multicast broadcast traffic also has attributes that allow the riser interconnect to be provisioned with less bandwidth than that which is allowed based on input/output cabling on the floor side to the local service recipients. For example, multicast broadcast bandwidth from the floor side of the switching element to the riser side is reduced by 100 times due to the replicated nature (multiplexing one signal traversing the riser side to n local service recipients on the floor side of the switching element) of this type of service. One riser side broadcast signal, for example, can be replicated many times on many floors, causing a significant reduction in riser traffic requirements.

In some embodiments, bandwidth provisioned for input/output ports on the riser side of each switching element coupled to the interconnect ring is less than the combined bandwidth provisioned for input/output ports on the floor side of each switching element. In some embodiments, the reduction of bandwidth that occurs across the switching node enables the high capacity interconnect riser ring to have improved bandwidth usage over conventional cabling techniques and act as a non-blocking switch between other switching nodes that make up the distributed switch of the network under defined traffic conditions, such as those described above. Conventional cabling requires that all bandwidth coming onto the floor (in the case of transport or access) or originating on the floor (application servers and/or management servers) and being directed to another floor, has an amount of bandwidth that may approach that which is allocated from the floor to the common switching room at the site. Furthermore, with conventional cabling techniques there is a greater opportunity for mistakes in cabling that can lead to problems with blocking. As described above, embodiments of the present invention allow for less riser bandwidth to be provisioned in and out of riser side ports of the switching element than in and out of floor side ports of the switching element. Therefore, embodiments of the present invention provide a more efficient use of resources. A more efficient use of resources generally translates into a less costly system to install, maintain, and upgrade.

In some embodiments, riser efficiency increases even more for a network that desires and implements different levels of protection for the switching element and for the network, as will be described in more detail below.

In some embodiments of the invention, the distributed switch described herein allows for a provisioning of bandwidth in a multi-floor NDC structure and multi-site connectivity as detailed below in Tables 1 and 2.

The tables illustrate examples of the use of a switching element, that is a part of the distributed switch, on each floor or at each site having collectively 640 Gbps of available bandwidth arranged as 320 Gbps of fan-in/out on the floor side of the switching element with a shared 320 Gbps ring/fabric on the riser or ring side of the switching element, 160 Gbps in each direction of the ring. When configured over six floors this would result in a 6×320 Gbps=1.92 Tbps of fan-in/out with a single shared 320 Gbps ring fabric. The shared ring fabric could be considered virtually non-blocking for the broadband multi-media service set as shown below. Virtually non-blocking meaning that the distributed switch is non-blocking under define traffic conditions.

### MULTI-FLOOR EXAMPLE

In Table 1, six floors in an NDC are defined in the left most column: OAM (operation, administration, management) WAN (wide area networks), Server (application hosting), two Access and Transport. The various broadband service types are shown across the top: VOD; VBC (video broadcast); HSD; VoIP; C&C; and VPN (virtual private network). The typical oversubscription ratio is shown below each broadband service. In some embodiments, this ratio aids in setting the bandwidth ratio for fan-in/out versus riser/ring.

Table 1 shows the bandwidth in Gbps on the floor side of the switching element on the left side, and riser side bandwidth on the right side of each respective cell of the table. The shaded cells in each column represent the origin of the particular services. For VOD, the service originates from the server floor and is provided to the transport and access-floors. For VBC, the service enters into the NDC on the transport floor from an upstream NDC and is provided to downstream NDCs via the transport floor and service recipients via the access floors. For HSD, the service originates from the WAN floor and is provided to downstream NDCs via the transport floor and service recipients via the access floors. For VoIP, the service originates from the WAN floor and is provided to downstream NDCs via the transport floor transport and service recipients via the access floors. For C&C, the service originates from the OAM floor and is connects with the server floor, transport floor, access floors. For VPN, the service enters into the NDC on the transport floor from an upstream NDC and is provided to downstream NDCs via the transport floor and service recipients via the access floors.

TABLE 1

| | | | | | | | | | | | | | Typical | |
|---|---|---|---|---|---|---|---|---|---|---|---|---|---|---|
| | | | VBC | | HSD | | VoIP | | C & C | | VPN | | per | |
| Floor | VOD 1:1 | | 50:1 | | 30:1 | | 2:1 | | 1:1 | | 2:1 | | Floor | |
| OAM Floor 6 | | | | | | | | | 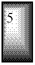 | 5 | | | 5 | 5 |
| WAN Floor 5 | | | | | 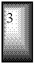 | 3 | 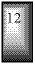 | 12 | | | 20 | 20 | 35 | 35 |
| Server Floor 4 | 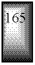 | 165 | | | | | | | 5 | 5 | | | 170 | 170 |
| Access | 55 | 55 | 100 | 2 | 30 | 1 | 8 | 4 | 5 | 5 | | | 148 | 67 |
| Floor 3 | | | | | | | | | | | | | | |
| Access | 55 | 55 | 100 | 2 | 30 | 1 | 8 | 4 | 5 | 5 | | | 148 | 67 |
| Floor 2 | | | | | | | | | | | | | | |
| Trans- port | 55 | 55 | 2 | 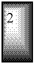 | 30 | 1 | 8 | 4 | 5 | 5 | 80 | 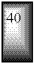 | 180 | 107 |
| Floor 1 | | | | 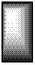 | | | | | | | | 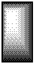 | | |
| Total | | | | | | | | | | | | 751 | 224 | |

The “Typical per Floor” column on right side of Table 1 shows total floor side bandwidth and riser side bandwidth. The total bandwidth for all floors of the “Typical per Floor” column is also shown. The riser side bandwidth is approximately half of the total value the riser side values for each floor due to the fact that the bandwidth of the riser side of the switching element is accounted for both on the floor the switching element is located, as well as the at least two other floors to which traffic is directed. The floor side bandwidth can be protected 1:1 and could potentially be up to 2×751 Gbps=1.52 Tbps Alternatively, floor side bandwidth could be 1:n protected for the access and server floors and 1:1 protected for the transport floor, yielding ˜751 Gbps×1.1+180 Gbps=1.07 Tbps.

### MULTI-SITE EXAMPLE

In Table 2, six sites having various functionality are defined in the left most column: M-NDC (Metro NDC) having VBC WAN and half of available VOD services; Access sites; and B-NDC (back-up NDC) having a remaining half of the available VOD. The various broadband service types are shown across the top and are the same as Table 4. The typical oversubscription ratio is shown below each broadband service.

The table shows the bandwidth in Gbps per site on a floor side of the switching element on the left side, and ring side bandwidth on the right side of each respective cell of the table. The shaded cells in each column reflect the origin of the particular services. In this case it is only Site 1 and Site 4 that are providing the services. Therefore Sites 1 and 2 would typically have a transport floor with switching element as well as at least one access floor with switching element. Sites 2, 3, 5 and 6 are for access to service recipients. The first row of numbers for Site 1 and Site 4 correspond to bandwidth values for the transport switching element and the second row of numbers correspond to bandwidth values for the access switching element at those sites. For example, for VOD at Site 1, an access switching element has 80 Gbps on the floor and ring sides of the transport switching element and 40 Gbps on the floor and riser side of the access switching element. However, for HSD at Site 1, an access switching element has 2 Gbps on the floor and ring sides of the transport switching element and 1 Gbps on the floor and 20 Gbps on the riser side of the access switching element, at least in part due to the oversubscription aspect of HSD.

| | VOD | | VBC | | HSD | | VoIP | | C & C | | VPN | | Typical | |
|---|---|---|---|---|---|---|---|---|---|---|---|---|---|---|
| Site | 1:1 | | 50:1 | | 30:1 | | 2:1 | | 1:1 | | 2:1 | | per Site | |
| M-NDC VBC/WAN ½ VOD Site 1 | 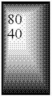 | 80 40 | 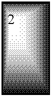 | 2 | 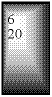 | 6 1 | 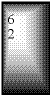 | 6 1 | 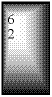 | 6 1 | 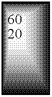 | 60 10 | 160 | 160 |
| Access | 40 | 40 | 20 | 2 | 20 | 1 | 2 | 1 | 1 | 1 | 20 | 10 | 103 | 55 |
| Site 2 | | | | | | | | | | | | | | |
| Access | 40 | 40 | 20 | 2 | 20 | 1 | 2 | 1 | 1 | 1 | 20 | 10 | 103 | 55 |
| Site 3 | | | | | | | | | | | | | | |
| B-NDC ½ VOD Site 4 | 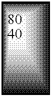 | 40 | 20 | 2 | 20 | 1 | 2 | 1 | 1 | 1 | 20 | 10 | 143 | 15 |
| Access | 40 | 40 | 20 | 2 | 20 | 1 | 2 | 1 | 1 | 1 | 20 | 10 | 103 | 55 |
| Site 5 | | | | | | | | | | | | | | |
| Access | 40 | 40 | 20 | 2 | 20 | 1 | 2 | 1 | 1 | 1 | 20 | 10 | 103 | 55 |
| Site 6 | | | | | | | | | | | | | | |
| Total | | | | | | | | | | | | | 715 | 192 |

The “Typical per Site” column on right side of Table 2 shows total floor side bandwidth and ring side bandwidth. The total bandwidth for all sites of the “Typical per Site” column is also shown. The ring side bandwidth is approximately half of the total value the ring side values for each site due to the fact that the bandwidth of the ring side of the switching element is accounted for both at the site the switching element is located, as well as the at least two other sites to which traffic is directed. Note the 715 Gbps can be also protected 1:1 and could potentially be 2×715 gbps=1.43 Tbps or 1:n protected for the access and server/application hosting sites, such as site 1 and site 4 and 1:1 protected for the sites having VPN services. (˜715 gbps×1.1+120 Gbps=0.906 Tbps)

More generally, VBC, HSD, VoIP and VPN services can be overscheduled to different values, greater of less than those described in the table above depending on a desired implementation. It is also to be understood that different types of bandwidth allocation in the table above are purely meant as examples for types of content and sizes of bandwidth. More generally, these values are considered to be implementation specific.

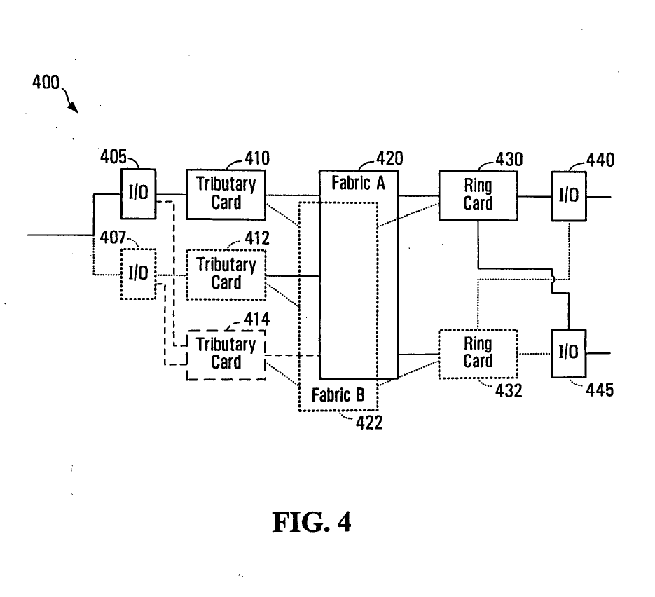

The switching element used in the above-described distributed switch can be implemented in a chassis-based module. FIG. 4 shows an example of components involved in such a chassis-based module, generally indicated at 400. Connection of components in the module 400 will be described first based on a primary path for basic operation without protection. Connection of protection components in the module 400 will then be described to illustrate various levels of protection that can be obtained by the chassis-based module design.

A first group of input/output ports 405 on the floor side of the switching element are coupled to a first tributary card 410. Tributary card is used in the context that the chassis card is used to connect to a tributary on the floor side of the switching element. Functionality of the tributary card is implementation specific. The tributary card 410 is coupled to a first switching fabric 420. The first switching fabric 420 is coupled to a ring card 430. Ring card is used in the context that the chassis card is used to connect to the ring on the riser side of the switching element. Functionality of the tributary card is implementation specific. The ring card 430 is coupled to a first group of input/output ports 440 on the riser side of the switching element and a third group of input/output ports 445 on the riser side of the switching element for coupling to the high capacity interconnect ring.

To provide 1:1 or 1+1 port protection a second group of input/output ports 407 is included on the floor side of the switching element connected with the same inputs and outputs as the first group of input/output ports 405. The second group of input/output ports 407 is coupled to a second tributary card 412 (which provides 1:1 or 1+1 card protection for the tributary card as well) and the second tributary card 412 is coupled to the first switching fabric 420. The first switching fabric 420 is coupled to the ring card 430. The ring card 430 is coupled to the second group of input/output ports 440 and the third group of input/output ports 445 on the riser side of the switching element.

To provide 1:n tributary card protection connectivity is provided from all I/O ports to one designated protection tributary card 414 which acts as a standby for 410, 412 and potentially more tributary cards. Tributary card 414 can detect a failure in one of the other cards and take over its function. It is similarly connected to fabric 420 and fabric 420 is connected to ring card 430 as described above. The ring card 430 is coupled to the second group of input/output ports 440 and the third group of input/output ports 445 on the riser side of the switching element.

To provide 1:1 or 1+1 switching fabric protection the first, second, and third tributary cards 410,412,414 (or some combination of the three tributary cards depending on the type of protection implemented) are connected with a second switching fabric 422. The second switching fabric 422 is coupled to the ring card 430. The ring card 430 is coupled to the second group of input/output ports 440 and the third group of input/output ports 445 on the riser side of the switching element.

To provide 1:1 or 1+1 ring card protection a second ring card 432 is included on the riser side of the switching element. If switching fabric protection is used, both first and second switching fabrics 420,422 are connected to the second ring card 432. The second ring card 432 is connected to the second and third groups of input/output ports 440,445 on the riser side of the switching element in the same manner as the first ring card as described above.

In some embodiments of the invention, the chassis based module design enables a low initial cost as cabling from the floor side to the input/output ports on the switching element can be done independently from expensive active cards.

FIG. 4 is an example implementing all of the described types of protection. More generally, it is to be understood that the use of each type of protection is implementation specific and as such in some embodiments of the invention not all of the protection features are implemented.

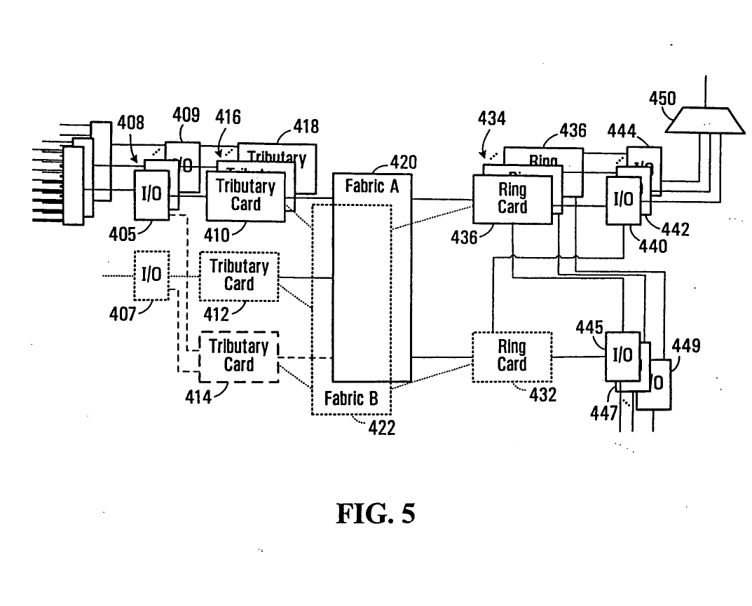

When there is a desire for increased bandwidth in the network, and especially when the various links in the network have been pre-cabled, network switching elements can be upgraded easily. FIG. 5 provides an example of how the chassis-based model can be scaled for increased bandwidth. FIG. 5 has similar components and connectivity to the components in FIG. 4. The main difference in FIG. 5 is that the primary unprotected path of FIG. 4 has been scaled by adding additional groups of input/output ports 408,409 for input and output cabling that has been pre-cabled to and/or on the floor. Each of the additional groups of input/output ports 408,409 are coupled to respective tributary cards 416,418, which are in turn coupled to at least the first switching fabric 420. Additional ring cards 434,436 are also added to the module by connecting them to at least the first switching fabric 420. Additional groups of input/output ports 442,444 on the riser side can also be added and connected to the respective additional ring cards 434,436.

In some embodiments, inputs and outputs of the input/output ports 440,442,444 are combined onto one or more. cables using one or more multiplexers, such that fewer cables are used in the high capacity riser interconnect than the total number of inputs and outputs from the input/output ports 440,442,444. For example, multiplexer 450 in FIG. 5 combines the inputs and/or outputs into a single cable forming a link to another switching element in the high capacity riser interconnect. In other embodiments, the multiple input/output ports 440,442,444 are connected to respective individual cables that collectively comprise the high capacity riser interconnect.

The same protection measures shown in FIG. 4 are also included in FIG. 5. It is to be understood that it may be desirable to also scale some or all of the protection measures when primary path bandwidth is scaled. In some embodiments, scaling the protection measures is implemented in a similar manner to scaling the primary path bandwidth described above.

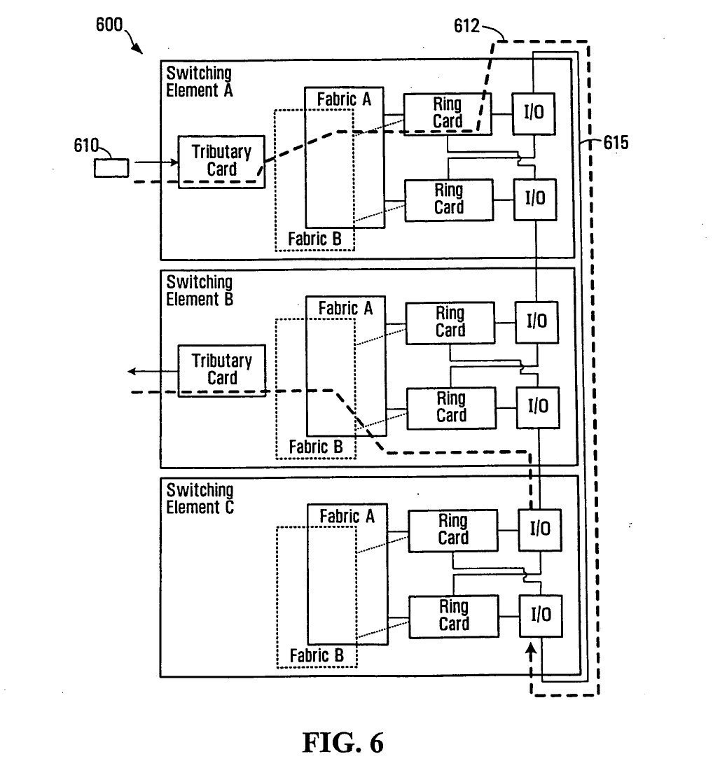

Referring to FIG. 6, an example of how an embodiment of the distributed switch functions will now be described. Three switching elements, of essentially the same type as shown in FIG. 4 are included in a local ring of a multi-floor site, generally indicated at 600. Switching element A is on a third floor, switching element B is on a second floor and switching element C is on a first floor. A packet 610 addressed for a port on the floor side of switching element B follows a path indicated by dashed line 612.

The packet 610 is supplied to a tributary card in switching element A via a floor side I/O port (not shown). The packet 610 is transmitted to the switching fabric, the ring card and the riser side input/output card of switching element A, at which point it enters the high capacity riser interconnect 615. The packet travels around the high capacity riser interconnect 615 to switching element C. A tagging mechanism ensures that switching element C understands that the packet 610 is not destined for switching element C and is to forward the packet 610 to switching element B. The packet 610 again enters the high capacity riser interconnect 615 until it reaches switching element B. The packet is received at the riser side input/output port of switching element B and is transmitted to the ring card, the switching fabric and tributary card of switching element B. The packet 610 is output to an appropriate floor side input/output port of switching element B.

It is to be understood that should the switch fabric in switching element A makes an initial decision of which direction the traffic should travel in the riser. In the above example, the switch fabric has decided that 615 is the best path (perhaps there is congestion on the other path, even if the other path is shortest path).

The above example may apply to many different instances of use in the distributed switch. In one instance, a VoD packet is provided by an application server on an application floor to a switching element on that floor and then is put onto the riser interconnect. The VOD packet bypasses the transport floor, is received by a switching element on the access floor and is ultimately transmitted to a local service recipient. Alternatively, another instance may be a multicast broadcast packet is provided by an upstream NDC and is received by a switching element on a transport floor. The multicast broadcast packet is transmitted from the switching element on the transport floor to a switching element on the application floor. The multicast broadcast packet bypasses the access floor, is received by the switching element on the application floor and is ultimately stored in an application server for later use. In some embodiments, in the case of multicast, the tagging mechanism can instruct that the same packet be dropped at multiple switching elements (such as a ‘drop and continue’ instruction) thus reducing the quantity of riser bandwidth that is needed to distribute broadcast to multiple points in the network.

In some embodiments the tagging mechanism described above is a forwarding table, which is set up at system turn-on via auto-discovery. The table is updated when switching elements are added or removed from the network. In some embodiments, such a tagging mechanism enables spacial re-use of bandwidth on the high capacity bandwidth interconnect. For example, as the bandwidth is destined for switching element B from switching element A, via switching element C, the bandwidth from switching element B to switching element A can be used in this direction for traffic from switching element B to switching element A.

The tagging mechanism is similar to that which is used in resilient packet ring (RPR) schemes. However, a significant difference between those schemes and the mechanism used by embodiments of the present invention, is that the switching fabric internal to the switching elements is included in the mechanism. While typically RPR schemes do not utilize components of a switching element beyond the input/output ports on the riser side of the switching element and the ring cards to determine whether to traverse particular switching elements or not, that fact that embodiments of the present invention include the internal switching fabric in the tagging mechanism contributes to the efficient use of the distributed switch.

In some embodiments, the tagging mechanism includes a switching element identification and the switching element identification is used to identify at least one of: a geographical location; a unique identity; an ownership of organization using the switching element; and an application delivered by the switching element.

In some embodiments of the invention, the switching element described herein provides a significant efficiency improvement by only allowing unique services to traverse the riser with maximum efficiency as the switching element provides signal replication (broadcast and multi-cast) required on any given floor and removal of any idle frames from tributary ports. A penalty for interface protection is also negated as protection signals can be created via duplication on the floor side of the switching element as opposed to multiple unique signals having to traverse the riser or leaving the signals unprotected, as is often the case.

In some embodiments of the invention, adding additional chassis to the network, changing cards in chassis, upgrading software, and other maintenance activities are non-service affecting due to the distributed nature of the switching elements in the network and the chassis-based module design of the individual switching elements.

In some embodiments of the invention, the NDCs act under a centralized operation scheme. A centralized operation scheme involves a single location managing or controlling other remote downstream locations. For example, a Tier 1 Metro NDC maintains personnel on the various floors to manage downstream NDCs, such as configuring or provisioning the bandwidth in the downstream NDCs. Tier 2 and 2/3 NDCs may or may not have personnel on respective floors of those NDCs. Tier 3 NDCs would typically by unmanned, with personnel only going to those sites when equipment needs to be checked or replaced. A Tier 1 NDC in a centralized broadband network can be used as a Test Access Point (TAP) and a Management Access Point (MAP) and Security Access Point (SAP).

In some embodiments, a centralized operation scheme provides that the Tier 1 NDC includes transport, access, application hosting, and management and control floors with respective switching elements of the type described herein operating in combination as a distributed switch. In some embodiments, the Tier 2, Tier 3 and/or Tier 2/3 NDCs have only access and transport floor with respective switching elements of the type described herein. In this manner the Tier 1 NDC hosts the content and distributes it to the Tier 2, Tier 3 and/or Tier 2/3 NDCs. However it is to be understood that the Tier 2, Tier 3 and/or Tier 2/3 NDCs could have application hosting and management and control floors. For example, when a customer base around a particular Tier 2, Tier 3 and/or Tier 2/3 NDC expands, it may be advantageous to install an application hosting floor to meet increased demand for services. The Tier 1 NDC can then supply services directly to the local service recipients as before via the access floor of the Tier 2, Tier 3 and/or Tier 2/3 NDC if necessary, but the particular Tier 2, Tier 3 and/or Tier 2/3 NDC can now receive content from the Tier 1 NDC, store it, and distribute it, under the control of the Tier 1 NDC.

In some embodiments, the distributed switch provides very high availability, for example 99.9999%+ uptime for the NDC, as the distributed switch forms the backbone of the NDC and in some cases the network linking multiple NDCs as well. Other embodiments provide high availability to a level that is acceptable to a user and is implementation specific based at least in part on levels of protection and component redundancy in a chassis-based module.

Communications travel on the network and interact with embodiments of the invention at primarily OSI (open system interconnection) Layer 0-2. In some embodiments, the invention may also support interaction with Layer 3 functionality. More generally, communications travelling on the network that interact with embodiments of the invention and are used in managing network traffic are implementation specific and are specific to desires and uses of a particular user and/or service provider.

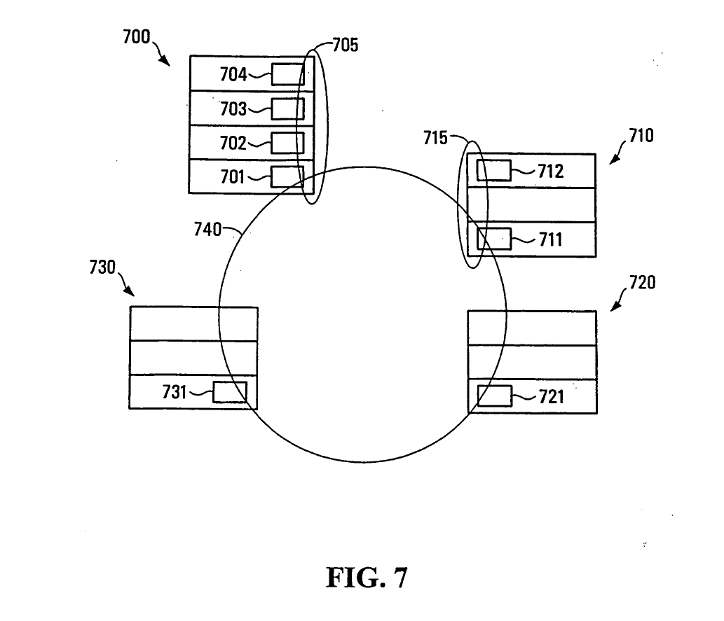

While the invention has generally been described in view of multiple floors at a single site, the same concept can be applied to multiple sites. For example, in some embodiments, sites having one or more switching elements of the type described herein are dispersed around a campus or even a metro network. An example of this is shown in FIG. 7.

A first site 700, a second site 710, a third site 720 and a fourth site 730 are coupled together with a high capacity interconnect ring 740. The first site 700 has four switching elements 701,702,703,704 on different floors of the site connected by a high capacity interconnect riser ring 705 in a manner described above. The second site 710 has two switching elements 711,712 and which are connected by a high capacity interconnect riser ring 715 in a manner described above. The second site 720 and the fourth site 730, each include a single switching element 721,731 of the type described herein. The high capacity interconnect ring 740 connects switching elements 701,711,721,731 in the four sites.

FIG. 7 is an example a ring of sites forming in combination a distributed switch. It is to be understood that any particular site may or may not also include multiple switching elements on respective floors of the site being connected with a high capacity interconnect riser ring.

The same benefits of the distributed switch operating over multiple floors also apply to multiple sites, but the media types, i.e. cabling between sites, are slightly different so as to offer longer reaches on a ring (eg. 10-60 kms). Therefore, a catastrophic site failure experienced by a network having switching elements at each site in the network acting collectively as a distributed switch, can be overcome in the ring system by distributing key functionality of each site over multiple sites, in the same way as different functionality is distributed on different floors as described in the multi-floor scenario. In some embodiments, the key functionality is distributed to at least 2 sites. More generally, the number of sites to which key functionality is distributed or replicated is an implementation specific concern. In this manner end users can always gain access to critical network resources.

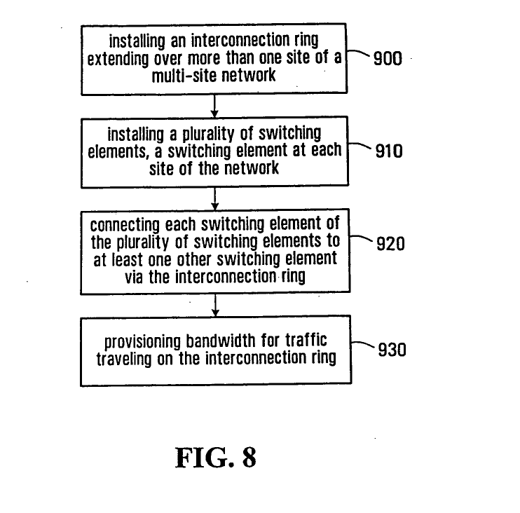

Referring to FIG. 8, a method for use with a distributed switch of the type described above will now be described. The method includes a first method step 900 of installing an interconnection ring extending over more than one site of a multi-site network. After installing the interconnection ring, which in some embodiments is considered to be pre-cabling as described above, a further method step 910 includes installing a plurality of switching elements in which a switching element is located at each site of the network. In another step of the method 920, each switching element is connected to at least one other switching element via the interconnection ring. After the switching elements are connected to the interconnection ring, a further step 930 includes provisioning bandwidth for traffic travelling on the interconnection ring. The provisioning of bandwidth may in part be based on one or more of oversubscription of services, multiplexing of services and/or distribution of bandwidth amongst the plurality of switching elements. As is described herein, the plurality of switching elements collectively provides a non-blocking connection between any two switching elements of the site under defined traffic conditions.

Some embodiments of the method further include reviewing the bandwidth provisioning of the plurality of switching elements of the network on a periodic basis and re-provisioning bandwidth as capacity needs of the network change. In some embodiments, reviewing and re-provisioning of bandwidth is done based on the centralized model in which the reviewing and re-provisioning is done from a central location for all sites collectively forming the multi-site distributed switch. In other embodiments, the reviewing and re-provisioning is performed based on a decentralized model in which the reviewing and re-provisioning is capable of being done from more than site.

The method can be further applied to one or more sites of the multi-site network in which the site has multiple floors. In some embodiments, the method for a multi-floor site would incorporate similar steps to those described above for multiple sites, but based on multiple floors of the site as opposed to multiple sites.

Some embodiments of the invention are intended to replace SONET equipment in the network. SONET systems distribute timing information, also known as synchronization, between devices to ensure proper operation of the broadband network. Synchronization is basically deciding on a common timing of the digital signal transitions. As a result, much of the equipment that talks to the SONET gear also relies on this timing signal in order to perform their tasks.

Such a synchronization system has a hierarchy which typically has a Cesium clock as a primary reference, also know as “Stratum 1”. The level of the “Stratum” refers to the acceptable accuracy of the timing reference. The master reference must be the best accuracy and is referred to as Stratum 1. As accuracy (and typically cost) drops, other names are used for the reference, including Stratum 2, 3, and so on. For when connectivity to the primary reference source is lost, SONET gear has a built in ‘holdover timing reference’ of Stratum 3, which is meant to keep the network going for a known period of time, with the SONET system acting as the primary reference, until connectivity to the Stratum 1 can be restored. Ethernet links are asynchronous and are defined as 100 PPM for basic link timing/clock recovery. Voice, digital and optical systems are generally 20 PPM with traceability features back to Stratum 1.

Some embodiments of the invention provide a similar concept in the distributed switch. This operates as follows: at least one switching element is configured with optional hardware which includes a Stratum 3 holdover function, an interface to an external timing reference (for example, DS1 or BITS) and a connection via the distributed switch to the other switching elements forming the distributed switch. Some embodiments use two connections in case the at least one switching element is isolated from the network due to failure of the sychronization card or the entire at least one switching element.

When a physical link such as a 10 GigE WAN PHY is used as a logical part of the ring, or a part of a much larger ring, it already has framing in its structure that supports the propagation of timing references. In some embodiments, this framing structure is used in order for nodes to participate in this function.

In some embodiments the external timing reference is propagated to all the other switching elements connected with the WAN-PHY by using the optional hardware to insert the required timing information into the 10 G LAN PHY and each floor/site is configured (as desired) with the timing reference hardware-for use on its floor/site. In the case of a loss of the primary external reference, the holdover Stratum 3 in the hardware would then be used to propagate the timing reference until the primary connectivity is restored.

With this feature enabled, the distributed switch can propagate a timing reference inserted at any one switching element to any or all of the other switching elements, and provide a backup timing reference in the case of a primary reference failure.

In some embodiments of the invention, by substituting Ethernet LAN PHY (100 ppm) with Ethernet WAN PHY (20 ppm), path, section and line overhead will offer SONET synchronization options with traceability to Stratum 1.

U.S. patent application No. <Client Reference Number 15204RO> entitled “OE Sync/Clock Distribution”, filed on Mar. 8, 2002, which is assigned to the assignee of the present invention, provides further detail on implementing a synchronization process that could be utilized in conjunction with embodiments of the present invention.

Another application for the multi-site distributed switch is for grid computing and storage applications across MAN and WAN. Today's data centre is usually confined to one floor that includes primary servers and storage with at least a second one floor data center as backup for storage. Future grid networking may include separate compute data centers, primary storage data centers, backup data centers and remote sensor data centers (an observatory, CERN, etc. . . . ). These applications could exploit embodiments of the described distributed switch. Therefore, embodiments of the invention are suitable for university, health care, exploration and research applications where data storage and processing requires “virtual non-blocking” access across multiple floors or sites in buildings, campus, metro, or WAN.

Numerous modifications and variations of the present invention are possible in light of the above teachings. It is therefore to be understood that within the scope of the appended claims, the invention may be practised otherwise than as specifically described herein.

1. A distributed switch for use in a broadband multimedia communication network comprising:
an interconnection ring extending over more than one floor of a site in the network;
a plurality of switching elements, each network switching element on a different floor of the site in the network, wherein each switching element is coupled to at least one other switching element via the interconnection ring;
wherein the plurality of switching elements collectively provide a non-blocking connection between any two switching elements of the site under defined traffic conditions.

2. The distributed switch of claim 1, wherein the defined traffic conditions are at least in part based on one or more of: oversubscription of services, multiplexing of services, and distribution of bandwidth amongst the plurality of switching elements.

3. The distributed switch of claim 1, wherein bandwidth provisioned for input/output ports of each switching element coupled to the interconnect ring is less than the combined bandwidth provisioned for input/output ports of each switching element coupled to links that are coupled to the interconnect ring via the switch.

4. The distributed switch of claim 1, wherein at least one switching element is coupled to at least one of:
at least one local service recipient;
at least one switching element at a remote site from the site comprising the plurality of switching elements;
at least one application server;
at least one gateway to another network; and
at least one management and control server.

5. The distributed switch of claim 1, further comprising:
at least one remote site each comprising one or more switching elements;
a second interconnection ring;
a switching element of the plurality of switching elements of the site and a switching element of the one or more switching elements of the at least one remote site coupled together via the second interconnection ring,
wherein the switching element of the at least one remote site and the plurality of switching elements collectively provide a non-blocking connection between any two switching elements of the site and the remote site under defined traffic conditions.

6. The distributed switch of claim 1, the plurality of switching elements comprising a first switching element on a first floor, a second switching element on a second floor, and a third switching element on a third floor, wherein:
the first switching element on the first floor is coupled to one or more switching elements at the site and one or more switching elements at remote sites, the first switching element adapted for switching signals to and from the one or more switching elements at remote sites and the one or more switching elements to which the first switching element is coupled;
the second switching element on the second floor of the site is coupled to one or more switching elements at the site and one or more local service recipients, the second switching element adapted for switching signals to and from the one or more local service recipients and the one or more switching elements to which the second switching element is coupled; and
the third network element on the third floor of the site is coupled to one or more switching elements at the site and at least one application server and/or at least one network gateway, the third network element adapted for switching signals to and from the at least one application server and/or at least one network gateway and the one or more switching elements to which the third switching element is coupled.

7. The distributed switch of claim 6 further comprising a fourth switching element on a fourth floor of the site, wherein;
the fourth switching element is coupled to one or more switching elements at the site and one or more management and control servers, the fourth switching element adapted for switching signals to and from the one or more management and control servers and the one or more switching elements to which the fourth switching element is coupled.

8. The distributed switch of claim 6, wherein there are more than one of any of the first switching element, second switching element and third switching element, each located on a respective additional floor.

9. The distributed switch of claim 1 used in communicating any one or more of a combination of signal types consisting of voice, data, internet, multi-cast video, uni-cast video, file and block storage, and compute instruction sets.

10. The distributed switch of claim 1, wherein the high capacity cabling interconnection ring uses at least one of Ethernet protocol or SONET protocol as the physical media.

11. A switching device for use in the distributed switch of claim 1 comprising:
a first plurality of input/output ports for receiving and sending signals to and from other switching elements located on different floors of the multi-floor site;
at least one ring card coupled to the plurality of first input/output ports;
a switching fabric coupled to the at least one first ring card;
at least one tributary card coupled to the switching fabric;
a second plurality of input/output ports for receiving and sending signals to input/outputs on the floor of the multi-floor site on which the switching element is located, the second plurality of input/output ports coupled to outputs of the at least one tributary card;
wherein when coupled together with one or more similar switching elements on different floors, the switching elements collectively forming a distributed switch to provide a non-blocking connection between any two switching elements of the site under defined traffic conditions.

12. The switching device of claim 11, wherein protection is provided by having redundant components in the network element, the redundant components consisting of one or more of additional input/output ports, ring cards, tributary cards and additional switching fabrics.

13. The switching device of claim 11, wherein tributary card, ring card and switching fabric additions or replacements within the switching device, software upgrades and other maintenance do not disrupt ongoing service of the switching device, the distributed switch of which the switching device is a part, or the broadband multimedia communication network of which the distributed switch is a part.

14. A method for use with a distributed switch in a broadband multimedia network comprising:
installing an interconnection ring extending over more than one site of a multi-site network;
installing a plurality of switching elements, a switching element at each site of the network;
connecting each switching element to at least one other switching element via the interconnection ring;
provisioning bandwidth for traffic travelling on the interconnection ring in part based on one or more of: oversubscription of services, multiplexing of services, and distribution of bandwidth amongst the plurality of switching elements;
wherein the plurality of switching elements collectively provide a non-blocking connection between any two switching elements of the site under defined traffic conditions.

15. The method of claim 14 further comprising:
reviewing the bandwidth provisioning of the plurality of switching elements of the network on a periodic basis;
re-provisioning bandwidth as capacity needs of the network change.

16. The method of claim 14, further comprising the steps of:
installing a second interconnection ring extending over multiple floors of a site including more than one floor in the multi-site network;
installing a plurality of switching elements, a switching element on each floor of the site;
connecting each switching element to at least one other switching element via the interconnection ring;
provisioning bandwidth for traffic travelling on the second interconnection ring in part based on one or more of: oversubscription of services, multiplexing of services, and distribution of bandwidth amongst the plurality of switching elements.

17. The distributed switch of claim 1, wherein at least one of the plurality of switching elements is adapted to supply a timing reference synchronization signal to any or all of the other switching elements of the plurality of switching elements in the distributed switch when there is a loss of a primary synchronization signal.

18. The switching element of claim 11, wherein a tagging mechanism is used by the switching element to forward packets on the interconnect ring, the tagging mechanism involving the switching fabric internal to the switching elements, wherein the tagging mechanism includes a switching element identification and the switching element identification is used to identify at least one of: a geographical location; a unique identity; an ownership of organization using the switching element; and an application delivered by the switching element.

19. The switching element of claim 11, wherein the switching element is adapted to provide signal replication on a respective floor of the site.

20. The switching element of claim 11, further comprising:
an interface to an external timing reference;
Stratum 3 holdover functionality;
wherein the switching element is adapted to supply a timing reference synchronization signal from the external timing reference to the plurality of switching elements in the distributed switch when there is a loss of a primary synchronization signal.
